(19) United States
(12) Patent Application Publication
(10) Pub. No.: US 2012/0044127 A1
(43) Pub. Date: Feb. 23, 2012

(54) TERMINAL APPARATUS

(76) Inventor: Ryutaro Mashiko, Osaka (JP)

(21) Appl. No.: 13/266,499

(22) PCT Filed: Mar. 11, 2010
(86) PCT No.: PCT/JP2010/054113

§ 371 Date: Oct. 27, 2011

(30) Foreign Application Priority Data
Apr. 28, 2009 (JP) 2009-109812

(51) Int. Cl. G09G 5/00

(52) U.S. Cl. 345/2.2

(57) ABSTRACT

Provided is a terminal apparatus that is able to, when outputting an image and letting it display on an external display apparatus, keep on displaying the same image on the external display apparatus, even when operations are executed that will display an image you do not want to show to the current viewers of the external display apparatus, due to receiving phone calls or e-mails. The terminal apparatus (indicated by an example: mobile terminal apparatus (1)) is enabled to output screens to the external display apparatus (indicated by an example: TV 4). The mobile terminal apparatus (1) is provided with a displaying portion (14), and a different-output control portion (indicated by an example: output-destination determining/control portion (21)). When the output-destination determining/control portion (21) detects operation signal of the main body of the mobile terminal apparatus (1), caused by an operation input portion (17) or the like, while displaying the image of the mobile terminal apparatus on TV 4, it continues the display of the image on TV 4 and executes different-output control to display on the displaying portion (14) another image that is different from the image.

### TECHNICAL FIELD

The present invention relates to a terminal apparatus, and, more specifically, to a terminal apparatus capable of being connected to an external displaying apparatus and outputting an image to the external displaying apparatus.

### BACKGROUND ART

Conventionally, a portable terminal apparatus such as a portable telephone, a portable information terminal (PDA: Personal Digital Assistance), or a mobile personal computer (PC) has a type thereof that includes a function of outputting an image to an external displaying apparatus connected to the type thereof.

Patent Document 1 discloses a portable terminal apparatus capable of, when the portable terminal apparatus causes a large-size audio-visual apparatus to reproduce a video image and a sound: restricting data to be output to the audio-visual apparatus such that display such as display of reception of electronic mail displayed on a display of the portable terminal apparatus is not displayed on an external display screen; and, in contrast, sending out data that is not reproducible in the portable terminal apparatus.

### PRIOR ART DOCUMENT

### Patent Document

Patent Document 1: Japanese Laid-Open Patent Publication No. 2006-262190

### SUMMARY OF THE INVENTION

### Problems that the Invention is to Solve

In the case where an image to be displayed on a displaying portion of a portable terminal apparatus is output to an external displaying apparatus and is caused to be displayed thereon, when an event occurs such as arrival of electronic mail or a call, the image output to the external displaying apparatus is changed corresponding to the event. Therefore, viewers other than a user of the portable terminal apparatus can consequently view information on the event that is, for example, information on the transmission origin of the electronic mail or the call origin on the external displaying apparatus.

According to the technique described in Patent Document 1, when the large-size audio-visual apparatus (the external displaying apparatus) is caused to execute reproduction, a preliminary setting can be made to restrict data to be sent out to the external displaying apparatus such that display such as display of reception of electronic mail displayed on the display of the portable terminal apparatus is not displayed on an external display screen.

However, according to this technique, to distinguish open data to be displayed on the external displaying apparatus and viewed by the user with other viewers and private data that the user of the portable terminal apparatus would like to view by him/herself without displaying the private data on the external displaying apparatus from each other, a setting needs to be made to correlate in advance attribute information indicating whether each piece of data is private data or open data with the kind of the data (for example, received electronic mail, a reception event, or remaining battery power amount). Therefore, labor for this setting is necessary and the data to be sent out to the external displaying apparatus is automatically restricted based on the setting for the attribute information. Therefore, the user can not easily execute on site an operation to output or restrict an image corresponding to the circumstances where the other viewers are user's family members, user's friends, coworkers in user's workplace, or some other persons, or what image is currently displayed.

The present invention was conceived in view of the above circumstances and the object thereof is to provide a terminal apparatus that, in the case where an image is output to an external displaying apparatus and the external displaying apparatus is caused to display the image, is able to continue display of the same image on the external displaying apparatus even when the user executes an operation to cause another image to be displayed that the user does not want to show to the current viewers of the external displaying apparatus in response to arrival of a call, reception of electronic mail, etc.

### Means to Solve the Problems

To solve the problems, a first technical means of the present invention is a terminal apparatus capable of outputting an image to an external displaying apparatus, comprising: a displaying portion; and a different-output control portion that, when the different-output control portion detects an operation signal of a main body of the terminal apparatus during display of the image on the external displaying apparatus, continues the display of the image on the external displaying apparatus and executes different-output control to display on the displaying portion another image that is different from the image.

A second technical means of the present invention is the terminal apparatus as defined in the first technical means, further comprising: an external operation signal receiving portion that receives an external operation signal from the external displaying apparatus; and an operation origin determining portion that determines an operation origin from a result of determining which one of the external operation signal and the operation signal is detected, wherein the different-output control portion executes the different-output control when an operation origin determined by the operation origin determining portion is the operation signal during the display of the image on the external displaying apparatus.

A third technical means of the present invention is the terminal apparatus as defined in the second technical means, wherein the external operation signal is a remote control operation signal received through the external displaying apparatus from a remote controller to control the external displaying apparatus.

A fourth technical means of the present invention is the terminal apparatus as defined in any one of the first to third technical means, wherein the different-output control portion executes the different-output control when the different-output control portion detects as the operation signal any one of an input signal of an operation key, a signal indicating detection of moving of the terminal apparatus, and a signal indicating detection of variation of a physical shape of the terminal apparatus.

### EFFECT OF THE INVENTION

According to the terminal apparatus of the present invention, in the case where the terminal apparatus outputs the image to the external displaying apparatus and causes the external displaying apparatus to display the image, even when the user executes an operation to cause another image to be displayed that the user does not want to show to the current viewers of the external displaying apparatus due to arrival of a call, reception of electronic mail, etc., the display of the image on the external displaying apparatus is enabled to continue.

### BRIEF DESCRIPTION OF DRAWINGS

FIG. 1 is a diagram of an exemplary configuration of a display system including a portable terminal apparatus according to an embodiment of the present invention and a television connected to the portable terminal apparatus.

FIG. 2 is a diagram of an example of an operation and display of the time when a connection is started and that of the time when a television remote control is operated in the display system of FIG. 1.

FIG. 3 is a diagram of an example of an operation and display of the time when the portable terminal apparatus is operated and that of the time when the television remote control is operated in the display system of FIG. 1.

FIG. 4 is a flowchart for explaining an example of a process procedure that corresponds to the example of the operation and the display of FIG. 2.

FIG. 5 is a flowchart for explaining an example of a process procedure that corresponds to the example of the operation and the display of FIG. 3.

FIG. 6 is a schematic diagram of a frame structure of a CEC command transmitted and received between the portable terminal apparatus and the television in the process procedures of FIGS. 4 and 5.

FIG. 7 is a flowchart for explaining an exemplary process executed for occurrence of an event of a connection or a disconnection to/from the television, and executed by the portable terminal apparatus in the display system of FIG. 1.

FIG. 8 is a flowchart for explaining an exemplary process executed for occurrence of an event of a user operation, and executed by the portable terminal apparatus in the display system of FIG. 1.

FIG. 9 is a diagram of another example of the operation and the display of the time when a connection is started, that of the time when the television remote control is operated, and that of the time when the portable terminal apparatus is operated in the display system of FIG. 1.

FIG. 10 is a flowchart for explaining an example of a process procedure that corresponds to the example of the operation and the display of FIG. 9.

FIG. 11 is a flowchart for explaining another exemplary process executed for the occurrence of the event of the connection or the disconnection to/from the television, and executed by the portable terminal apparatus in the display system of FIG. 1.

FIG. 12 is a flowchart for explaining another exemplary process for the occurrence of the event of the user operation, and executed by the portable terminal apparatus in the display system of FIG. 1.

### MODES FOR CARRYING OUT THE INVENTION

A terminal apparatus according to the present invention is able to output an image to an external displaying apparatus. A portable terminal apparatus will be taken as the terminal apparatus. However, portability is not indispensable to the terminal apparatus. An apparatus capable of receiving a call and electronic mail will be taken as an example as the portable terminal apparatus. However, this apparatus may have no function of transmitting and receiving a call or electronic mail. The terminal apparatus will be described taking a television apparatus (hereinafter, simply “TV”) as an example of the external displaying apparatus. However, the external displaying apparatus only has to be provided with a displaying portion to display an image and a communicating portion to communicate with the portable terminal apparatus, and may be a simple monitor, a digital photo frame, etc.

A connection using an HDMI (High-Definition Multimedia Interface) cable will be exemplified as the connection to output an image. However, various connecting methods may be employed each capable of outputting an image from the portable terminal apparatus to the external displaying apparatus such as the TV, such as a cable connection using i.LINK (a registered trademark) and a wireless connection such as Bluetooth (a registered trademark) or a wireless LAN (Local Area Network). Even under the HDMI standard, etc., the terminal apparatus is able to be adapted to transmit image data or a CEC (Consumer Electronics Control) command as a wireless signal by simultaneously employing a wireless connection standard such as a wireless LAN standard.

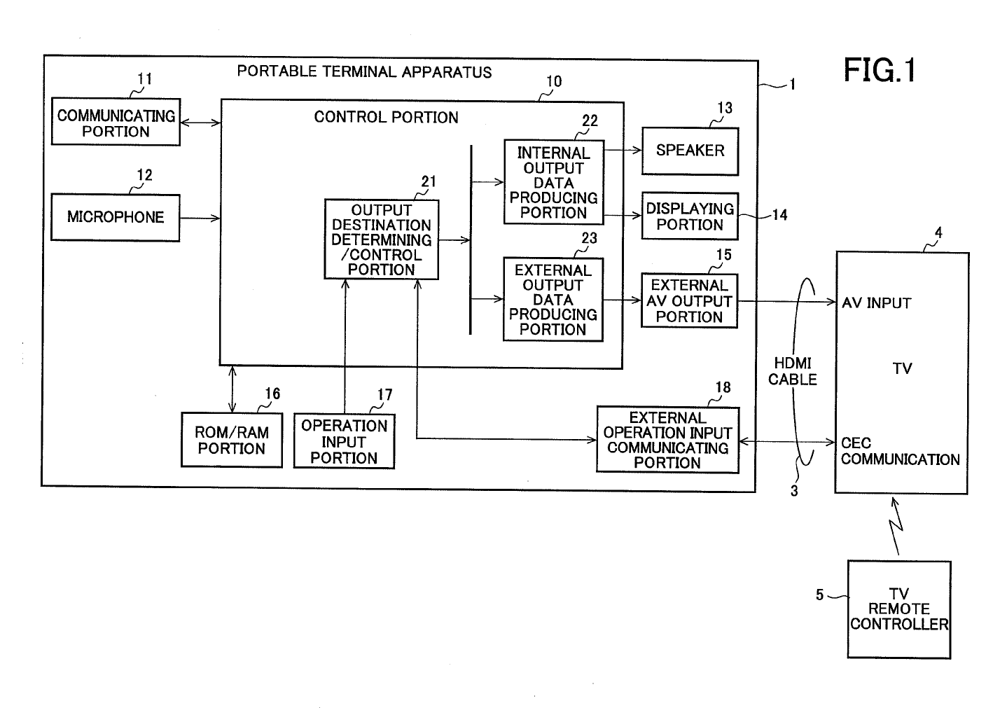

FIG. 1 is a diagram of an exemplary configuration of a display system including the portable terminal apparatus according to an embodiment of the present invention and the TV connected to the portable terminal apparatus. The display system exemplified in FIG. 1 includes the portable terminal apparatus 1 and the TV 4 that are connected to each other by an HDMI cable 3. The TV 4 is attached with a TV remote controller 5 that is a remote controller for the TV 4.

In addition to a control portion 10 that controls the whole portable terminal apparatus 1, the portable terminal apparatus 1 includes a communicating portion 11, a microphone 12, a speaker 13, a displaying portion 14, an external AV output portion 15, a ROM (Read Only Memory)/RAM (Random Access Memory) portion 16, an operation input portion 17, and an external operation input communicating portion 18.

The communicating portion 11 executes communication with a base station or a relaying station. The microphone 12 inputs a sound from a user during a call, etc. The speaker 13 outputs a sound, etc., of the counterpart during a call received by the communicating portion 11. The displaying portion 14 displays an image indicated by image data output from an internal output data producing portion 22 described later. The external AV output portion 15 is an interface (I/F) to output the image data to the TV 4 through a TMDS (Transition Minimized Differential Signaling) line of the HDMI cable 3. The image data is data output from an external output data producing portion 23 described later. The ROM/RAM portion 16 has programs to be executed by the control portion 10, setting information, etc., stored therein.

The operation input portion 17 has a group of operational keys and inputs an operation from the user by detecting pressing down of each operational key, transferring to the control portion 10 an operational signal that corresponds to the operational key, etc. The operational keys may be configured by a touch panel incorporated in the displaying portion 14, and a key image displayed on the displaying portion 14.

The external operation input communicating portion 18 is an I/F that receives a CEC command concerning an external operation transmitted from the TV 4 and transmits a CEC command to the TV 4 through a CEC line of the HDMI cable 3. An “external operation” refers to a key operation on the TV remote controller or a key operation on an operation input portion disposed on the main body of the TV 4.

The external operation input communicating portion 18 is an example of an external operation signal receiving portion that receives an external operation signal. An “external operation signal” is an operation signal such as a CEC command concerning the external operation from the TV 4 and is, for example, an operation signal such as a CEC command to change an image output by the portable terminal apparatus 1. As above, the portable terminal apparatus 1 is able to receive the external operation signal from the TV 4 and is also able to change the image output according to the external operation signal. Not to mention, the external operation signal may be a signal transmitted to execute an operation other than that for changing the output image at the portable terminal apparatus 1.

As described for the external operation, utilization of a remote control operation signal received from the TV remote controller 5 through the TV 4 to control the TV 4 as the external operation signal enables the user to execute the operation at hand. In addition to HDMI cable 3, a connection method is applicable that enables an operation signal from the TV remote controller 5 to be received by the portable terminal apparatus 1 through the TV 4, that is, that enables a command corresponding to so-called “remote control passing-through” to be transmitted from the TV 4 to the portable terminal apparatus 1.

The control portion 10 includes an output destination determining/control portion 21, the internal output data producing portion 22, and the external output data producing portion 23. The output destination determining/control portion 21 will be described later.

The internal output data producing portion 22 produces image data to be displayed on the displaying portion 14 and sound data to be output to the speaker 13, reading the programs and the setting information from the ROM/RAM portion 16 when necessary, and outputs the image data and the sound data respectively to the displaying portion 14 and the speaker 13.

The internal output data producing portion 22 produces: contents of a UI (User Interface) image to be displayed on the displaying portion 14 of the portable terminal apparatus 1, other still images such as photographs stored in the portable terminal apparatus 1, and moving images (video images); and image data such as a One-Seg video image acquirable using the portable terminal apparatus 1 through the communicating portion 11, etc., and a WEB image, and the portion 22 outputs the contents and the image data to the displaying portion 14. The internal output data producing portion 22 produces sound data such as sounds accompanying these images and music contents stored in the portable terminal apparatus 1, and outputs the sound data to the speaker 13.

The external output data producing portion 23 produces image data (and sound data) to be output to the TV 4 reading the programs and the setting information from the ROM/RAM portion 16 when necessary, and outputs the image data (and the sound data) to the external AV output portion 15. In this manner, incorporation of mainly the external output data producing portion 23 and the external AV output portion 15 in the portable terminal apparatus 1 enables the portable terminal apparatus 1 to output an image (and a sound) to the TV 4 through the HDMI cable 3.

Similarly to the objects for the internal output data producing portion 22 to output, the external output data producing portion 23 produces: contents of a UI image, other still images, and a moving image; and image data such as a One-Seg video image and a WEB image. The external output data producing portion 23 outputs the contents and the image data to the external AV output portion 15. The external output data producing portion 23 produces sound data such as sounds accompanying these images and music contents stored in the portable terminal apparatus 1, and outputs the sound data to the external AV output portion 15. The TV 4 only has to additionally include a sound output apparatus such as a speaker or a connecting terminal to an external speaker to enable the TV 4 to also output the sound data.

The portable terminal apparatus 1 includes a following different-output control portion described below as a main characteristic of the present invention. When the different-output control portion detects an operation signal of a portable terminal apparatus main body (hereinafter, “internal operation signal”) such as a signal of an operation being input using an operational key on the operation input portion 17 during display of an image from the portable terminal apparatus 1 on the TV 4, the different-output control portion continues the display of the image on the TV 4 and executes different-output control to display on the displaying portion 14 another image that is different from the image (an image presenting information that is different from the information displayed on the TV 4). In this different-output control, the different image to be displayed on the displaying portion 14 is basically an image that is applied with a process indicated by the internal operation signal, and is a different output from the image that is continuously displayed on the TV 4. An easy operation enables an image corresponding to the operation to be instantly displayed on the displaying portion 14, and enables the display on the TV 4 to have a content that is different from that of the display on the displaying portion 14.

As above, in case the portable terminal apparatus 1 includes an external operation signal receiving portion (a portion corresponding to a receiving portion in the external operation input communicating portion 18) which is able to receive an external operation signal, the control portion 10 needs to determine an operation origin to execute the different-output control.

Therefore, the portable terminal apparatus 1 includes an operation origin determining portion that determines an operation origin by determining which one of an external operation signal and an internal operation signal is detected. An example will be taken for description where the operation origin determining portion determines an operation origin based on a signal input thereinto. However, the operation origin determining portion may be adapted to determine an operation origin based simply on an input path, etc., of the operation signal (for example, by separating input terminals of the output destination determining/control portion 21 and determining from which terminal the operation signal is input).

The output destination determining/control portion 21 is an example of a portion that includes the above different-output control portion and this operation origin determining portion. The output destination determining/control portion 21 determines whether an operation origin is the TV 4 or the portable terminal apparatus 1 main body based on whether the signal is an external operation signal or an internal operation signal, and executes the different-output control. When the operation origin determined is the main body such as the operation input portion 17, the output destination determining/control portion 21 continues the display of the image on the TV 4 and displays on the displaying portion 14 another image that is different from the image.

As above, according to the portable terminal apparatus 1, in the case where the portable terminal apparatus 1 outputs an image to the TV 4 and causes the TV 4 to display the image, even when an operation is executed to display another image that a user does not want to show to the current viewers of the TV 4 due to arrival of a call, reception of electronic mail, etc., the display of the image on the TV 4 is able to be continued. When the user changes an image to be output watching the TV 4, the user is able to execute the change using an operation for the TV 4 on the TV remote controller 5, etc.

Even when the portable terminal apparatus 1 is adapted to include no external operation signal receiving portion, that is, when the portable terminal apparatus 1 does not include the operation origin determining portion, the above different-output control is executable. Therefore, even in the case where the portable terminal apparatus 1 is adapted to be able to receive no external operation signal and to include no operation origin determining portion that is exemplified by the output destination determining/control portion 21, when the portable terminal apparatus 1 outputs an image to the TV 4 and causes the TV 4 to display the image and a user has to execute an operation to display another image that the user does not want to show to the current viewers of the TV 4, an easy and instantly executable operation on the portable terminal apparatus 1 enables only the displaying portion 14 to display the other image that corresponds to the operation continuing the display of the image on the TV 4.

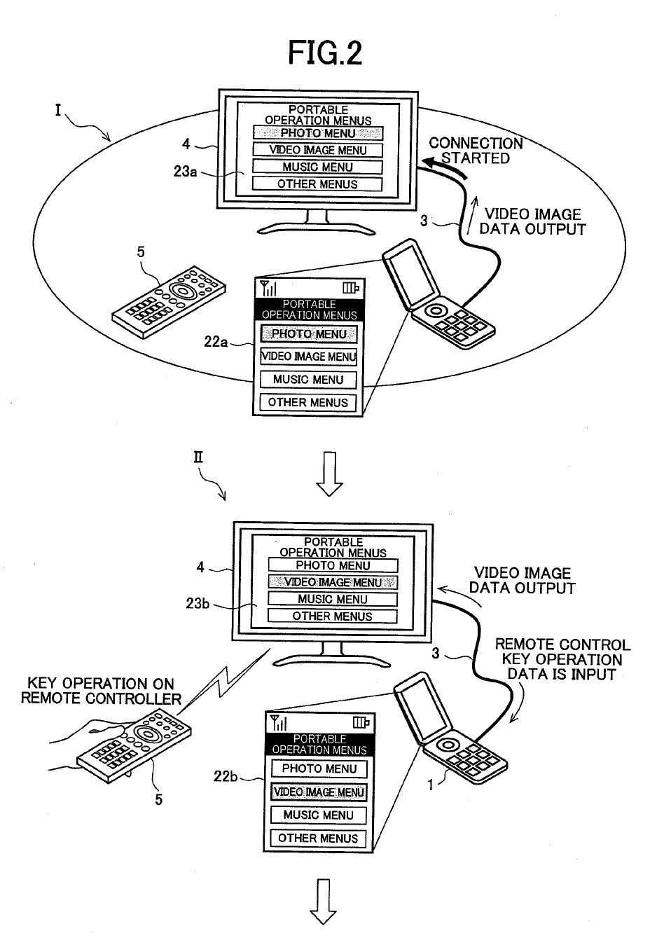

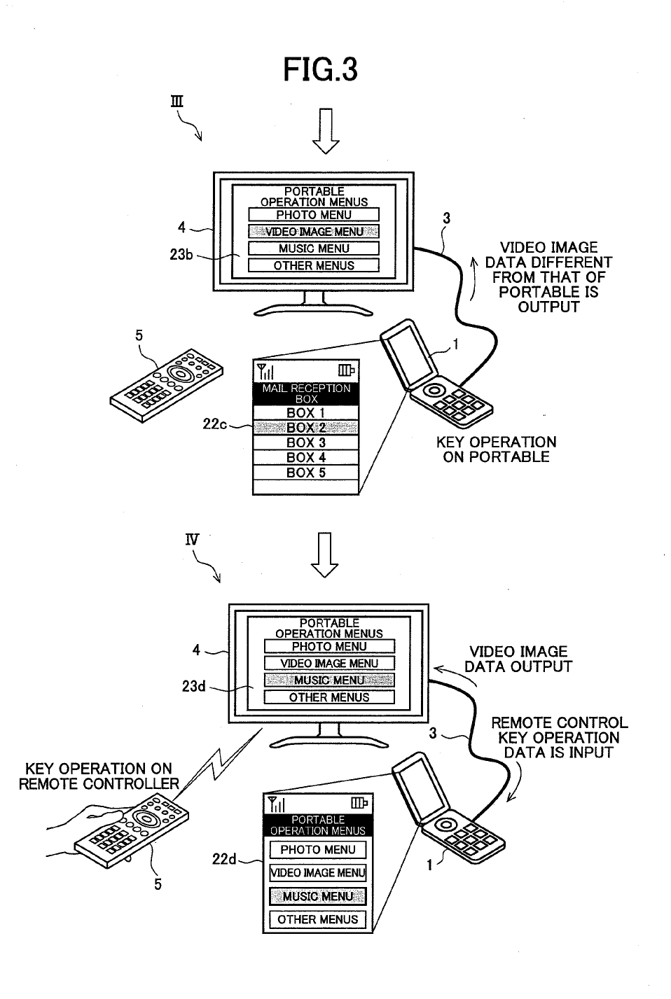

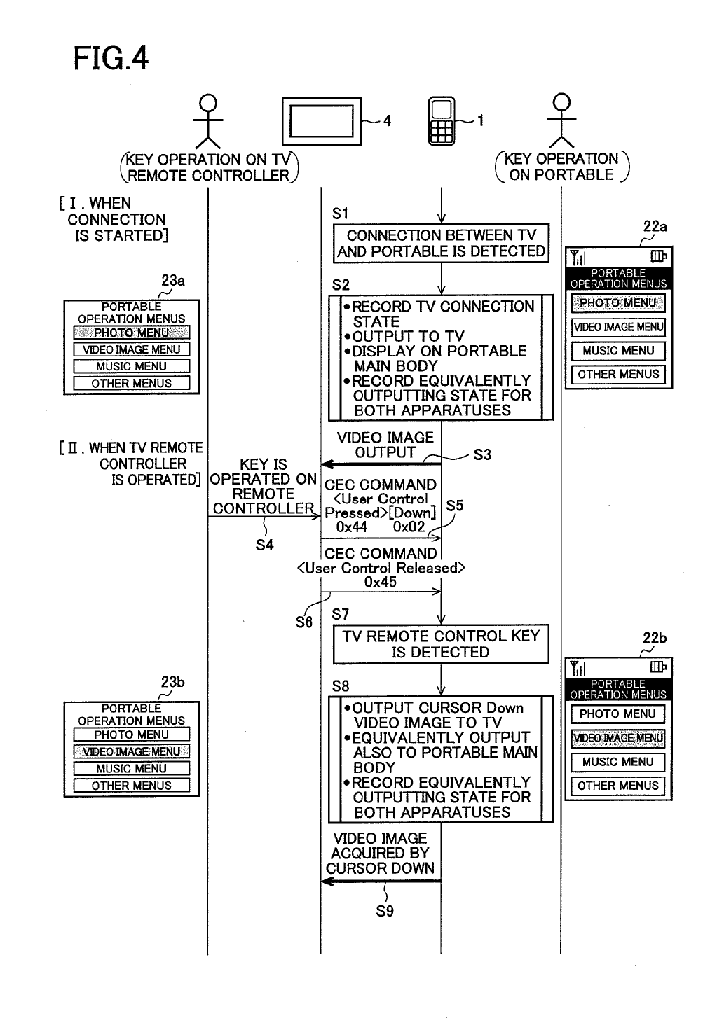

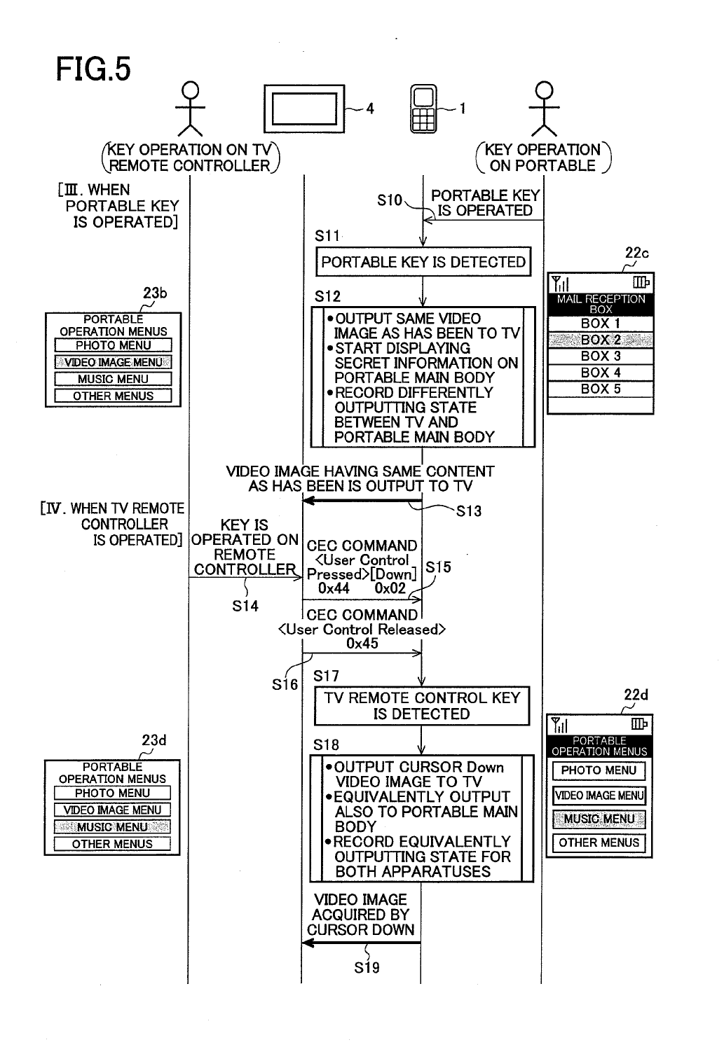

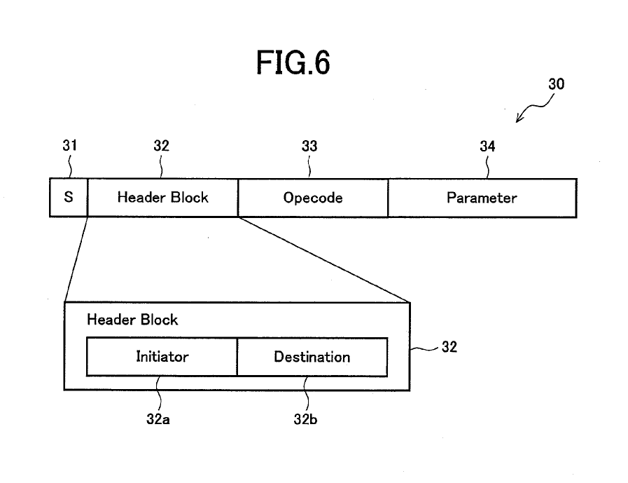

Specific examples of processes in the display system of FIG. 1 will be described with reference to FIGS. 2 to 8. An overview of the specific examples will be first described with reference to FIGS. 2 to 6. FIG. 2 is a diagram of an example of an operation and display of the time when a connection is started and that of the time when a television remote control is operated in the display system of FIG. 1. FIG. 3 is a diagram of an example of an operation and display of the time when the portable terminal apparatus is operated and that of the time when the television remote control is operated in the display system of FIG. 1. FIGS. 4 and 5 are flowcharts for explaining an example of a process procedure that corresponds to the examples of the operation and the display of FIGS. 2 and 3. FIG. 6 is a schematic diagram of a frame structure of a CEC command transmitted and received between the portable terminal apparatus and the TV in the process procedures of FIGS. 4 and 5.

The portable terminal apparatus 1 and the TV 4 are connected to each other by the HDMI cable 3 as represented by a state I of FIG. 2. At this time, the portable terminal apparatus 1 detects the connection (step S1). Next, the internal output data producing portion 22 automatically produces (or reads) a UI image 22a to select an output content and displays the UI image 22a on the displaying portion 14 of the portable terminal apparatus 1 (step S2). Control may be employed for a predetermined user operation on the portable terminal apparatus 1 to display the UI image 22a on the displaying portion 14. However, in this case, restriction is necessary to cause an operation signal generated by the predetermined user operation and the internal operation signal to differ from each other or to cause the different-output control to be not executed until the control by the predetermined user operation is completed.

At step S2, the external output data producing portion 23 automatically produces (or reads) a UI image 23a that is equivalent to the UI image 22a (a UI image formed from the UI image 22a by matching the size and the resolution of the UI image 22a with those of the displaying portion of the TV 4) and delivers the UI image 23a to the external AV output portion 15. Thereby, the external AV output portion 15 outputs the UI image 23a to the TV 4 through the HDMI cable 3 (step S3) and the TV 4 displays the UI image 23a on the displaying portion thereof. An image such as the UI image 23a produced by and input from the external output data producing portion 23 may be displayed after being applied with a scaling process such as enlarging by the TV 4. At step S2, etc., an output state of the displaying portion 14 and the TV 4 (at step S2, an output state where the displaying portion 14 and the TV 4 are in their equivalently outputting states) is recorded in the ROM/RAM portion 16 and is managed such that the current state is able to be grasped. States to be recorded can be a differently outputting state described later in addition to the equivalently outputting state at step S2.

It is assumed that a remote control key is operated by the user on the TV remote controller 5 from the state I (step S4). In this case, the procedure will be described assuming that a “Down” key for remote control passing-through is operated as in the state II. In CEC under the HDMI standard, in addition to the Down key, various remote control keys such as an Up key, a Left key, a Right key, and an Exit key are transferable to a CEC-supporting apparatus connected to the TV 4 by remote control passing-through.

The TV 4 receives using its receiving portion for the remote control a remote control signal transmitted by pressing down of the Down key for remote control passing-through, interprets the remote control signal to be the Down key for remote control passing-through, and transmits a CEC command <User Control Pressed> [Down] to the portable terminal apparatus 1 through the HDMI cable 3 (step S5). Thereafter, when a finger leaves this Down key, the TV 4 also receives this leaving, interprets this leaving to be leaving from the Down key, and transmits a CEC command <User Control Released> to the portable terminal apparatus 1 through the HDMI cable 3 (step S6).

A CEC command has a frame structure including a start bit (S) 31, a header block (Header Block) 32, and a control command (Opecode) 33, and a parameter (Parameter) 34 is added after the control command 33 when necessary, as exemplified by a CEC command 30 of FIG. 6. The header block 32 has a message transmission address (Initiator) 32a and a message reception address (Destination) 32b described therein as logical addresses. When the TV 4 receives a remote control operation signal from the TV remote controller 5, the TV 4 sets its own logical address to be the message transmission address 32a, sets a logical address of another CEC-supporting apparatus currently connected thereto to be the message reception address 32b, and transmits CEC commands like those of steps S5 and S6. A CEC-supporting apparatus: is able to determine the transmission origin of the message based on the message transmission address 32a; compares the message reception address 32b with its own transmission origin; and, thereby, is able to recognize whether the control command 33 following the address 32b is a command directed to the CEC-supporting apparatus itself.

The portable terminal apparatus 1 compares the message reception address 32b with its own logical address and, when these addresses coincide with each other, receives the CEC commands of steps S5 and S6 using the external operation input communicating portion 18. The output destination determining/control portion 21 interprets the message transmission address 32a of each of the CEC commands and detects that the CEC command indicates the external operation signal from the TV, that is, the pressing down of the TV remote control key (step S7).

Next, the control portion 10 interprets from the control command 33 the signal to be an external operation signal indicating the pressing down of the Down key, and accordingly informs the output destination determining/control portion 21 therein. The output destination determining/control portion 21 determines the TV 4 to be the output destination based on the fact that the signal is an external operation signal, and instructs the external output data producing portion 23 to produce a UI image 23b pointed by a cursor that is moved downward by one row from the UI image 23a. The external output data producing portion 23 produces the UI image 23b and delivers the UI image 23b to the external AV output portion 15 (step S8). Thereby, the external AV output portion 15 outputs the UI image 23b to the TV 4 through the HDMI cable 3 (step S9) and the TV 4 displays the UI image 23b on its own displaying portion.

At step S8, the output destination determining/control portion 21 determines the reception of the external operation signal and, therefore, also sends to the internal output data producing portion 22 an instruction to produce a UI image 22b that is equivalent to that of the TV 4. The internal output data producing portion 22 produces the UI image 22b according to the instruction and outputs the UI image 22b to the displaying portion 14 to cause the displaying portion 14 to display the UI image 22b. At step S8, the state of the above process (the equivalently output state) is managed as it is recorded in the ROM/RAM portion 16 such that the current state is able to be grasped.

It is assumed that an operation is executed on the operation input portion 17 of the portable terminal apparatus 1 from this state I or II (step S10). In this case, the procedure will be described assuming that an operation to display an electronic mail reception box is executed as in the state III. This operation may be regarded as an operation automatically executed in response to the reception of the electronic mail, or may be an operation executed by the user who desires to check the past electronic mail.

When the operation input portion 17 receives the operation to display the electronic mail reception box, the operation input portion 17 delivers to the control portion 10 an internal operation signal that indicates its process content. Thereby, the output destination determining/control portion 21 detects that the signal is not an external operation signal and is an internal operation signal, that is, detects the pressing down of an operation key of the portable terminal apparatus 1 (step S11).

The control portion 10 interprets the operation content (in this example, the displaying of the electronic mail reception box) from the internal operation signal and delivers the operation content to the output destination determining/control portion 21 therein. The output destination determining/control portion 21 determines that the output destination is the displaying portion 14 of the portable terminal apparatus 1 from the fact that the signal is an internal operation signal, and instructs the internal output data producing portion 22 to produce a UI image 22c that displays the electronic mail reception box. The internal output data producing portion 22 produces the UI image 22c and delivers the UI image 22c to the displaying portion 14 (step S12). Thereby, the displaying portion 14 displays the UI image 22c that includes information handled by the user as confidential information.

At step S12, the output destination determining/control portion 21 determines the reception of the internal operation signal. However, the output destination determining/control portion 21 instructs the external output data producing portion 23 to output the image as before (the UI image 23b). Naturally, when a moving image is output, an instruction is issued to continue the output of the moving image. Thereby, the external output data producing portion 23 and the external AV output portion 15 continue outputting their previous images (step S13).

At step S12, the state of the above process is recorded in the ROM/RAM portion 16 and is managed such that the current state is able to be grasped. Due to the transition from the state I or II to the state III, the state only has to be updated to the differently outputting state where the displaying portion 14 and the TV do not execute the equivalent outputting.

The case where the operation of the portable key is executed at step S10 can be the time when viewing is shifted to viewing of data that the user does not want to show to other persons (private data). The private data can be, for example, (1) data to manage the user him/herself of the portable terminal apparatus 1, (2) data related to the taste of the user him/herself, (3) data relating to the form of thought or the form of action of the user him/herself, (4) data only for the user him/herself to use, and (5) data of the record of past actions of the user him/herself (operation record/communication record).

The data of (1) can be the name, the telephone number, the electronic mail address of the user him/herself. The data of (2) can be, for example, specific photographs, specific moving images, specific music data, specific electronic book data, specific downloaded applications, data of a pedometer, a record of meals, a schedule, and specific documents. The data of (3) can be electronic mail and data folder names (mail box names). The data of (4) can be an address book and a record of calls and messages in a telephone answering portion. The data of (5) can be a call history, a use history and balance information of electronic money, etc., and a game record, in addition to a website browsing history, a shopping history, and book marks.

When the user desires to display such private data on the displaying portion 14, the user executes the operation on the operation input portion 17 and, thereby, is able to display the private data only on the displaying portion 14 without displaying the private data on the TV 4. For example, it is assumed that, when electronic mail reception occurs during viewing of the open data on TV 4 with the portable terminal apparatus 1 connected thereto, the user operates the portable terminal apparatus 1 main body to try to view electric mail received holding the portable terminal apparatus 1 in his/her hand. The operation of the portable terminal apparatus 1 main body causes only the displaying portion 14 to display the private data and maintains the display output to the TV 4. Therefore, the private data is able to be prevented from being displayed on the TV 4 and viewed by other persons.

Whether a piece of data corresponds to private data differs depending on a viewer of the TV 4. However, the user is able to determine the data to be private data and set the private data to be a different output when necessary. Therefore, a setting to determine whether a piece of data is private data does not need to be stored inside the portable terminal apparatus 1.

On the other hand, when data that may be open is viewed, the user only has to operate the portable terminal apparatus 1 using the TV remote controller 5 as described at step S4.

It is assumed that an operation on the TV remote controller 5 is accepted from the state III (step S14). In this case, when it is assumed that the pressing down of the Down key is accepted as in the state IV, the same processes as those at steps S5 to S9 (steps S15 to S19) are executed.

However, at step S18: the TV 4 displays a UI image 23d pointed by the cursor that is moved downward by one row from the UI image 23b; the displaying portion 14 also displays a UI image 22d pointed by the cursor that is moved downward by one row from the UI image 22c; and the state is updated from the differently outputting state to the equivalently outputting state.

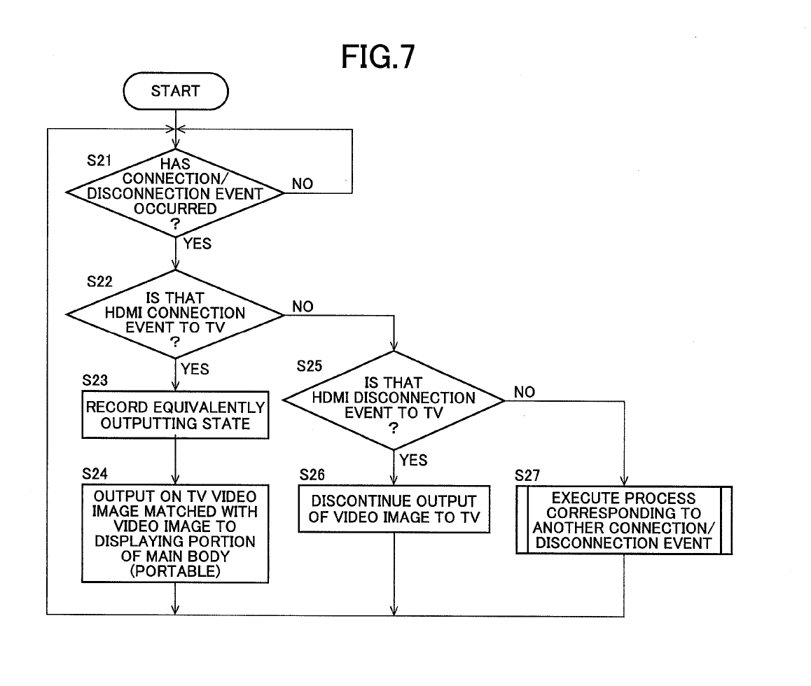

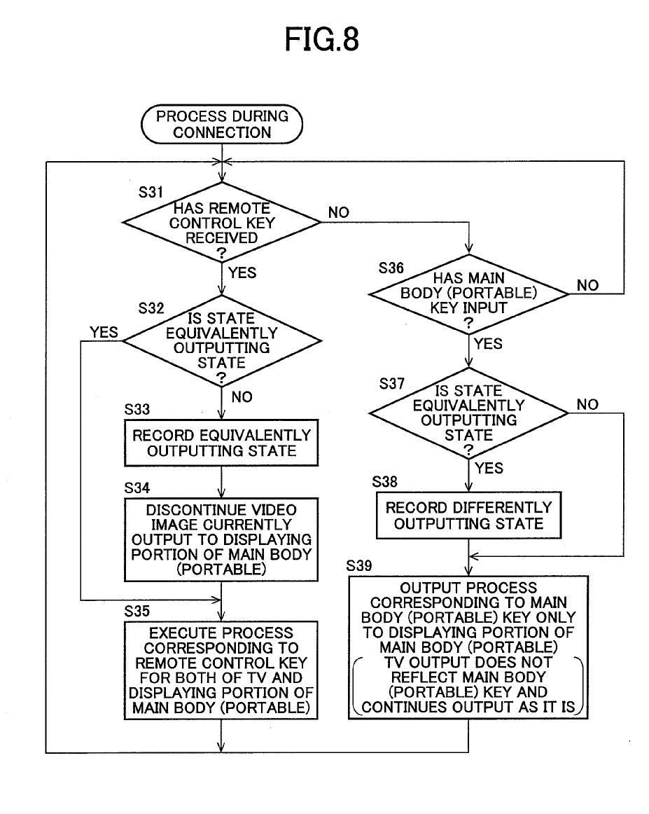

Next, a flow of processes in the portable terminal apparatus 1 will be described with reference to FIGS. 7 and 8. FIG. 7 is a flowchart for explaining an exemplary process executed for occurrence of an event of a connection or a disconnection to/from the TV and executed by the portable terminal apparatus in the display system of FIG. 1. FIG. 8 is a flowchart for explaining an exemplary process executed for occurrence of an event of a user operation and executed by the portable terminal apparatus in the display system of FIG. 1.

The event of a connection or a disconnection to/from the TV 4 will be described with reference to FIG. 7. The control portion 10 of the portable terminal apparatus 1 detects whether the event of a connection or a disconnection occurs concerning the connection to the TV 4 (step S21). When the event occurs, the control portion 10 determines whether the event is an event of an HDMI connection to the TV 4 (step S22). When the event of a connection or a disconnection is an event that “a connection is detected of the external operation input communicating portion 18 to the TV 4 through the HDMI cable 3”, it is able to be determine that the event is an event of an HDMI connection to the TV 4.

When the determination result is YES at step S22, it is recorded in the ROM/RAM portion 16 that the output destination determining/control portion 21 is in the equivalently outputting state (step S23). The output destination determining/control portion 21 selects the TV 4 as an output destination. The external output data producing portion 23 and the external AV output portion 15 output an image (a video image) equivalent to the image on the displaying portion 14 through the HDMI cable 3 (step S24). After step S24, the procedure returns to step S21. Due to these processes, the state becomes a display state like, for example, the state I of FIGS. 2 and 4. Any order of steps S23 and S24 may be employed.

On the other hand, when the determination result is NO at step S22, the control portion 10 determines whether the event is an event of a disconnection of the HDMI connection to the TV 4 (step S25). When the event of a connection or a disconnection detected at step S21 is an event that “the external operation input communicating portion 18 connected to the TV 4 through the HDMI cable 3 detects unplugging of the HDMI cable 3 at the portable terminal apparatus 1 or the TV 4”, it is able to be determined that the event is an event of HDMI disconnection from the TV 4.

When the determination result is YES at step S25, no output of any image to the TV 4 is necessary and, therefore, according to an instruction of the output destination determining/control portion 21, the external output data producing portion 23 and the external AV output portion 15 discontinue (stop) their output of the images through the HDMI cable 3 (step S26). This makes no change to the content of the display on the displaying portion 14. Thereafter, the procedure returns to step S21.

When the determination result is NO at step S25, the event is another event of a connection or a disconnection such as a connection or a disconnection to/from the TV 4 or another apparatus at a USB (Universal Serial Bus) cable. Therefore, the control portion 10 executes a process that corresponds to the event (step S27) and the procedure returns to step S21. This makes no change to the content of the display on each of the displaying portion 14 and the displaying portion of the TV 4.

Next, an event of a user operation will be described with reference to FIG. 8. The output destination determining/control portion 21 determines whether the portion 21 receives a remote control key (an external operation signal) (step S31). When it is determined that the portion 21 receives the signal (when the determination result is YES), the output destination determining/control portion 21 determines whether the state is the equivalently outputting state based on the record in the ROM/RAM portion 16 (step S32). When it is determined that the state is not the equivalently outputting state (when the determination result is NO), the output destination determining/control portion 21: updates the state of the ROM/RAM portion 16 to the equivalently outputting state; issues to the internal output data producing portion 22 an instruction to discontinue the image (video image) that is displayed on the displaying portion 14 until this time point; and discontinues the production and the outputting of the image that is displayed until this time point (step S34).

When the determination result is YES at step S32 and after the process of step S34, the output destination determining/control portion 21 instructs the internal output data producing portion 22 and the external output data producing portion 23 to execute a process and outputting corresponding to the remote control key. The internal output data producing portion 22 executes the process and the outputting for the displaying portion 14, and the external output data producing portion 23 and the external AV output portion 15 execute equivalent video image outputting through the HDMI cable 3 (step S35). Any order of steps S33 and S34 may be employed. After the process of step S35, only when the determination result is NO at step S32, the process of step S33 (the process of step S34 is included in the process of step S35) may be executed. After the process of step S35, the procedure returns to step S31. Due to these processes, the state becomes the display state like, for example, the state II of FIGS. 2 and 4.

On the other hand, when the determination result is NO at step S31, the output destination determining/control portion 21 determines whether an input of a key (a portable key) is executed on the operation input portion 17 (step S36). When it is determined that no input is executed, the procedure returns to step S31. When it is determined that an input of a portable key is executed (when the determination result is YES at step S36), the output destination determining/control portion 21 determines whether the state is the equivalently outputting state from the record in the ROM/RAM portion 16, etc., (step S37). When it is determined that the state is the equivalent outputting state (when the determination result is YES), the output destination determining/control portion 21 updates the state of the ROM/RAM portion 16 to the differently outputting state (step S38).

When the determination result is NO at step S37 and after the process of step S38, the output destination determining/control portion 21 receives the portable key and, therefore, the output destination determining/control portion 21 instructs the internal output data producing portion 22 to produce an image of the process and the outputting that correspond to the portable key (the internal operation signal). The displaying portion 14 displays the image (step S39). In the process of step S39, the video image output to the TV 4 is maintained, that is, no video image reflecting the portable key is output to the TV. After the process of step S39, only when the determination result is YES at step S37, the process of step S38 may be executed. After the process of step S39, the procedure returns to step S31. Due to these processes, the state becomes the display state like, for example, the state III of FIGS. 3 and 5.

According to the above processes, as a typical exemplary use, in the case where the content displayed on the displaying portion 14 of the portable terminal apparatus 1 is displayed on the display of the TV 4 connected to the portable terminal apparatus 1, when the operation to display electronic mail received by the portable terminal apparatus 1 is executed on the operation input portion 17 of the portable terminal apparatus 1, the displaying portion 14 of the portable terminal apparatus 1 at hand is able to be adapted to display the text of the electronic mail that is a new content and the display of the TV 4 connected thereto is able to be adapted not to display the text of the electronic mail that is the new content. Thereby, a user is able to refer to his/her secret information at hand (using the portable terminal apparatus 1) continuing showing the others the content originally displayed on the display.

As above, the portable terminal apparatus 1 according to the present invention has been described. However, the above different-output control portion may be adapted to execute the different-output control when the different-output control portion detects not only the input signal of the operation key but also either one of a signal indicating detection of moving of the portable terminal apparatus 1 and a signal indicating detection of variation of the physical shape of the portable terminal apparatus 1 as the internal operation signal. The different-output control portion may be adapted to execute the different-output control only when the different-output control portion detects any one of these three detections. Naturally, the different-output control portion may execute the different-output control only when the different-output control portion detects the moving or may execute the different-output control only when the different-output control portion detects the variation of the physical shape.

For the moving of the portable terminal apparatus 1, a sensor such as, for example, an acceleration sensor, etc., is loaded thereon and only has to be adapted to detect the moving of the position, a disposition angle, etc. For example, a user is able to execute the different-output control by only taking up in the user's hand the portable terminal apparatus 1 put on a table by the user or by only an operation of holding the portable terminal apparatus 1 in the user's hand and shaking it. For the variation of the physical shape of the portable terminal apparatus 1, a movable portion is disposed in the portable terminal apparatus 1 and only has to be adapted to be able to detect, for example, flip-opening, slide-opening, and a rotation of the displaying portion 14. The different-output control is able to be executed when the user only causes such variation of the physical shape.

As above, the different-output control is executed in response to the moving of the portable terminal apparatus 1 or the variation of the physical shape thereof and, thereby: it is able to more easily and instantly be determined that the operation origin is the portable terminal apparatus 1; and the secret information (the private data) is able to be displayed on the portable terminal apparatus 1 maintaining the display on the TV 4 as it is. Furthermore, such an action of the user as holding the portable terminal apparatus 1 in his/her hand or causing a change to the physical shape to be able to see the screen of the displaying portion 14 is a natural action executed to view the data on the portable terminal apparatus 1. Therefore, the display on the displaying portion 14 is able to be automatically executed by this natural action and display different from that on the displaying portion 14 is able to be executed on the TV 4. Therefore, the present invention is highly beneficial.

As above, the present invention has been described on the premise that the TV 4 is one that is connected to the portable terminal apparatus 1. However, even when a plurality of external displaying apparatuses such as the TV 4 are connected to the portable terminal apparatus 1, the present invention is applicable thereto.

The present invention has also been described on the premise that the data output from the portable terminal apparatus 1 to the external displaying apparatus such as the TV 4 is the image data (and the sound data). However, the present invention is also applicable to the case where only the sound data is output from the portable terminal apparatus to an external sound output apparatus. In this case, control to mute the sound only has to be executed instead of the different-output control and, preferably, the portable terminal apparatus 1 is adapted to be able to change the sound to output in response to an external operation signal from the external sound output apparatus similarly to the case of the image.

As above, the portable terminal apparatus according to the present invention has been described. However, the portable terminal apparatus is able to be adapted to execute control to cause the display of an image on the TV 4 not to be displayed not maintaining the display of the image on the TV 4 as it is, as another example where the differently outputting is executed when an internal operation signal is detected. Such discontinuation control will be described taking an example of the display system of FIG. 1 that transmits and receives the CEC command of FIG. 6.

The portable terminal apparatus 1 of the example includes a discontinuation control portion as follows. When the discontinuation control portion detects an internal operation signal such as an operation input using the key on the operation input portion 17 during display on the TV 4 of an image from the portable terminal apparatus 1, the discontinuation control portion executes control to discontinue the display (not to display) on the TV 4 of the image from the portable terminal apparatus 1. Hereinafter, this control is referred to as “non-display control”. This control will be described taking an example of an input using a key on the operation input portion as an internal operation signal. According to the non-display control, when accepting an operation of an operational key on the operation input portion 17, the discontinuation control portion is able to cause the display on the TV 4 not to be displayed. An easy operation is able to instantly cause the display on the TV 4 not to be displayed.

Next, an example will be taken of a method of setting the image from the portable terminal apparatus 1 not to be displayed on the TV 4. The discontinuation control portion may discontinue the output of the image from the portable terminal apparatus 1 to the TV 4 as the non-display control. The discontinuation of the output is able to be realized by an event such as producing no image data of the control portion 10 (the output destination determining/control portion 21) using the external output data producing portion 23, causing the output to the external AV output portion 15 to be discontinued using the external output data producing portion 23, or causing the output to the HDMI cable 3 to be discontinued using the external AV output portion 15. Due to this discontinuation of the output, no image is transmitted from the portable terminal apparatus 1 to the TV 4 and, therefore, the image from the portable terminal apparatus 1 is not displayed on the TV 4.

The discontinuation control portion outputs a control signal capable of causing the TV 4 to display no image from the portable terminal apparatus 1 (a control signal capable of discontinuing the display of the image) as the non-display control, as another method. Such a control signal can be, for example, a control signal to turn off the power of the TV 4 and a control signal to switch an input source of the TV 4 to a source other than the portable terminal apparatus 1. The control portion 10 (the output destination determining/control portion 21) only has to produce such a control signal and output the control signal to the TV 4 through the external operation input communicating portion 18. When this method is employed, preferably, the output of the image from the portable terminal apparatus 1 to the TV 4 is simultaneously discontinued as the non-display control. When two-way communication is enabled not through the HDMI cable 3 but through another path, the portable terminal apparatus 1 is able to transmit the control signal to the TV 4.

As above, when the portable terminal apparatus 1 is provided with the external operation signal receiving portion (a portion corresponding to the receiving portion in the external operation input communicating portion 18) and the portable terminal apparatus 1 is able to receive an external operation signal, the control portion 10 needs to determine the operation origin to execute the non-display control.

To do the above, the portable terminal apparatus 1 includes the operation origin determining portion that determines the operation origin by determining which of the external operation signal and the internal operation signal is input thereinto. An example will be taken and described where the operation origin determining portion determines the operation origin based on the signal input thereinto. However, the operation origin determining portion may be adapted to determine the operation origin based simply on the input path of the operation signal (for example, by separating input terminals of the output destination determining/control portion 21 and determining from which terminal the operation signal is input).

The output destination determining/control portion 21 is an example of a portion that includes the above discontinuation control portion and this operation origin determining portion. The output destination determining/control portion 21 determines whether the operation origin is the TV 4 or the portable terminal apparatus 1 main body by determining whether the signal is an external operation signal or an internal operation signal, executes the non-display control, and executes control to realize the non-display on the TV 4 when the operation origin determined is the operation input portion 17.

As described above, according to the portable terminal apparatus 1 in the example that is able to execute the non-display control, in the case where an image is output from the portable terminal apparatus 1 to the TV 4 and is displayed on the TV 4, when another image that the user does not want to show to the current viewers of the TV 4 is displayed in response to arrival of a call, reception of electronic mail, or switching of the image, an easy and instantly executable operation on the portable terminal apparatus 1 is able to easily, quickly, and on site discontinue the display of the other image on the TV 4. When the user changes the image to be output watching the TV 4, an operation using the TV remote controller 5, etc., for the TV 4 enables the execution of the change.

When the portable terminal apparatus 1 is configured to include no external operation signal receiving portion, that is, the above operation origin determining portion, the above non-display control is executable. Therefore, even with the portable terminal apparatus 1 adapted to be able to receive no external operation signal and to include no operation origin determining portion that is exemplified by the output destination determining/control portion 21, in the case where an image is output from the portable terminal apparatus 1 to the TV 4 and is displayed on the TV 4, when another image is displayed on the TV 4 that the user does not want to show to the current viewers of the TV 4, an easy and instantly executable operation on the portable terminal apparatus 1 easily, quickly, and on site enables discontinuation of the display of the other image on the TV 4.

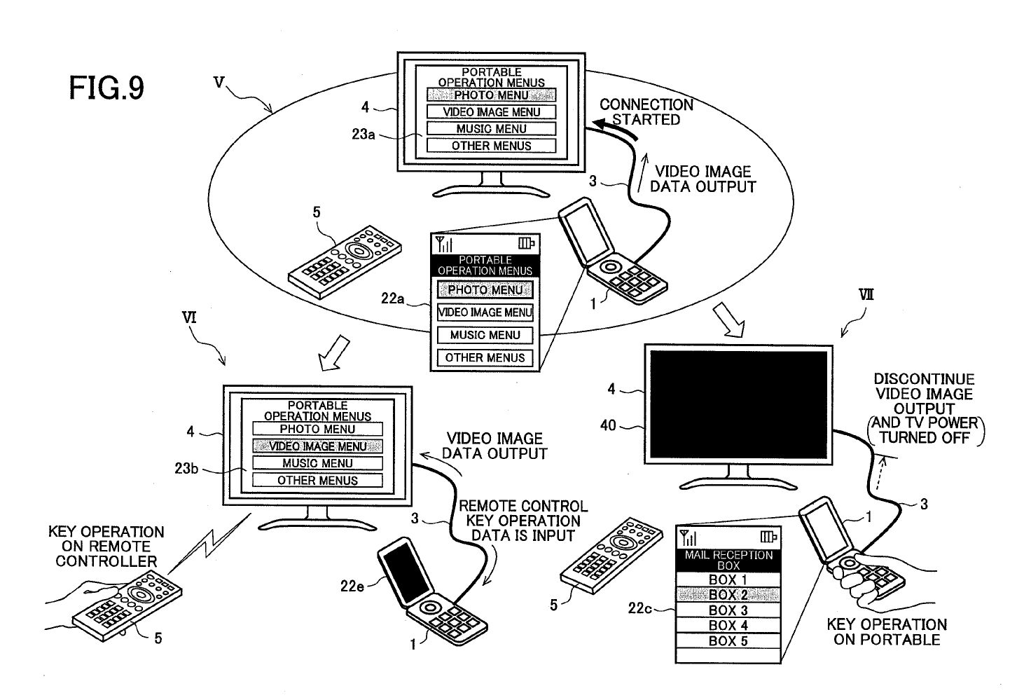

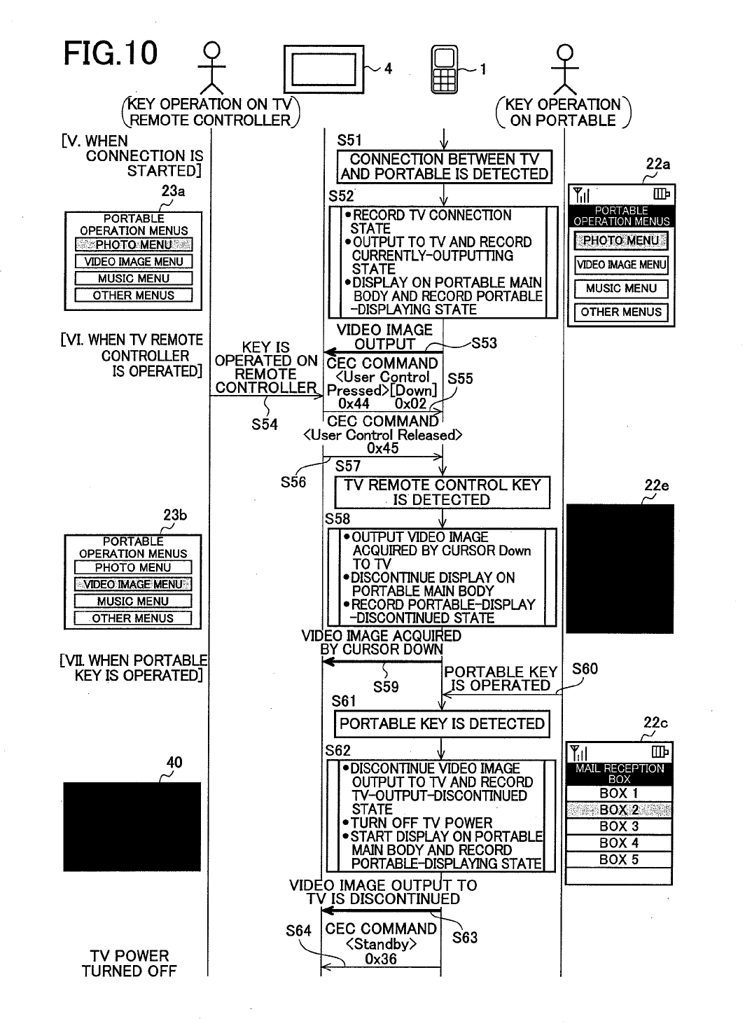

A specific example of processes in the display system of FIG. 1 adapted to be able to execute the non-display control will be described with reference to FIGS. 9 to 12. An overview of the specific example will first be described with reference to FIGS. 9, 10, and 6. FIG. 9 is a diagram of another example of the operation and the display of the time when a connection is started, that of the time when the TV remote control is operated, and that of the time when the portable terminal apparatus is operated in the display system of FIG. 1. FIG. 10 is a flowchart for explaining an example of a process procedure that corresponds to the example of the operation and the display of FIG. 9. FIG. 6 is also a schematic diagram of a frame structure of a CEC command transmitted and received between the portable terminal apparatus and the TV in the process procedures of FIG. 10.

The portable terminal apparatus 1 and the TV 4 are connected to each other by the HDMI cable 3 as represented by a state V of FIG. 9. At this time, the portable terminal apparatus 1 detects the connection (step S51). Next, the internal output data producing portion 22 automatically produces (or reads) the UI image 22a to select output contents and displays it on the displaying portion 14 of the portable terminal apparatus 1 (step S52). Control may be employed for a predetermined user operation on the portable terminal apparatus 1 to display the UI image 22a on the displaying portion 14. However, in this case, a restriction is necessary for the non-display control not to be executed until the time of the predetermined user operation.

At step S52, the external output data producing portion 23 automatically produces (or reads) the UI image 23a that is equivalent to the UI image 22a and delivers the UI image 23a to the external AV output portion 15. Thereby, the external AV output portion 15 outputs the UI image 23a to the TV 4 through the HDMI cable 3 (step S53) and the TV 4 displays the UI image 23a on the displaying portion thereof. An image such as the UI image 23a produced by and input from the external output data producing portion 23 may be displayed after being applied with a scaling process such as enlarging by the TV 4. At step S52, the state of this process (at least presence or absence of any output to the displaying portion 14 and presence or absence of any output to the TV 4) is recorded in the ROM/RAM portion 16 and is managed such that the current state is able to be grasped. States to be recorded can be a TV-connected state, a TV-outputting state, and portable-displaying state, etc.

It is assumed that a remote control key is operated by the user on the TV remote controller 5 from this state V (step S54). In this case, the procedure will be described assuming that the Down key for remote control passing-through is operated as in the state VI. As above, in CEC under the HDMI standard, various remote control keys are transferable to a CEC-supporting apparatus connected to the TV 4 by remote control passing-through.

The TV 4 receives using its receiving portion for the remote control a remote control signal transmitted by pressing down of the Down key for remote control passing-through and executes the same processes as those of steps S5, S6, and S7 of FIG. 4 (steps S55, S56 and S57).

Next, the control portion 10 interprets from the control command 33 the signal to be an external operation signal transmitted by the pressing down of the Down key, and accordingly informs the output destination determining/control portion 21 therein. The output destination determining/control portion 21 determines the TV 4 to be the output destination based on the fact that the signal is an external operation signal, and instructs the external output data producing portion 23 to produce a UI image 23b pointed by the cursor that is moved downward by one row from the UI image 23a. The external output data producing portion 23 produces the UI image 23b and delivers it to the external AV output portion 15 (step S58). Thereby, the external AV output portion 15 outputs the UI image 23b to the TV 4 through the HDMI cable 3 (step S59) and the TV 4 displays the UI image 23b on its own displaying portion.

At step S58, the output destination determining/control portion 21 determines the reception of the external operation signal and, therefore, sends to the internal output data producing portion 22 an instruction to discontinue the production of the image or an instruction to discontinue its output to the displaying portion 14. The internal output data producing portion 22 discontinues the display of the UI image 22a on the displaying portion 14 according to the instruction. Thereby, a black screen 22e is displayed and, therefore, unnecessary display is able to be stopped. Therefore, saving of power is facilitated. At step S58, the state of this process is recorded in the ROM/RAM portion 16 and is managed such that the current state is able to be grasped. The state only has to be updated from the portable-displaying state to a portable-displaying discontinuation state in response to the transition from the state V to the state VI.

As described at step S58, the portable terminal apparatus 1 may be adapted to include a main-body discontinuation control portion that discontinues display of an image (that is not limited to a same image as the image being output to the TV 4) on the displaying portion 14 when the operation origin determined is the TV 4. This main-body discontinuation control portion is also able to be exemplified by the output destination determining/control portion 21. As above, this discontinuation process is able to be executed by issuance of a production discontinuation instruction by the output destination determining/control portion 21 to the internal output data producing portion 22 or by issuance of an output discontinuation instruction thereby to the displaying portion 14 (and the speaker 13). The main-body discontinuation control portion is also applicable in a form thereof including the different-output control portion described with reference to FIGS. 2 to 8.

It is assumed that an operation is executed by the user on the operation input portion 17 of the portable terminal apparatus 1 from the state V or VI (step S60). In this case, the procedure will be described assuming that an operation to display an electronic mail reception box is executed as in the state VII. This operation may be regarded as an operation automatically executed in response to reception of electronic mail, or may be an operation executed by the user who desires to check the past electronic mail.

When the operation input portion 17 receives the operation to display the electronic mail reception box, the operation input portion 17 sends to the control portion 10 an internal operation signal that indicates its process content. Thereby, the output destination determining/control portion 21 detects that the signal is not an external operation signal and is an internal operation signal, that is, detects the pressing down of an operation key of the portable terminal apparatus 1 (step S61).

The control portion 10 interprets the operation content (in this example, the displaying of the electronic mail reception box) from the internal operation signal and sends the operation content to the output destination determining/control portion 21 therein. The output destination determining/control portion 21 determines that the output destination is the displaying portion 14 of the portable terminal apparatus 1 from the fact that the signal is an internal operation signal, and instructs the internal output data producing portion 22 to produce the UI image 22c that displays the electronic mail reception box. The internal output data producing portion 22 produces the UI image 22c and delivers it to the displaying portion 14 (step S62). Thereby, the displaying portion 14 displays the UI image 22c.

At step S62, the output destination determining/control portion 21 determines the reception of the internal operation signal and, therefore, sends an instruction to discontinue the production of the image or an instruction to discontinue the output to the external AV output portion 15, to the external output data producing portion 23. Thereby, the external output data producing portion 23 or the external AV output portion 15 discontinues its image output (video image output) (step S63).

At step S62, the output destination determining/control portion 21 also determines reception of an internal operation signal and, therefore, instructs the external operation input communicating portion 18 to produce and output a next CEC command (a CEC message). It is assumed that this CEC command is a command including the logical address of the portable terminal apparatus 1 itself (the external operation input communicating portion 18 itself) as the message transmission address 32a and the logical address of the TV 4 as the message reception address 32b and employing <Stanby> (a command indicating turning off of the power) as its control command. The external operation input communicating portion 18 produces this CEC command and transmits the CEC command through the HDMI cable 3 (step S64). Steps S63 and S64 discontinue the output of the image and the TV 4 receives this CEC command and turns off its own power (brings itself into a standby state). The displaying portion of the TV 4 displays a black screen 40.

At step S62, the state of the above process is recorded in the ROM/RAM portion 16 and is managed such that the current state is able to be grasped. The state only has to be updated to the portable-displaying state and TV-outputting discontinued state in response to the transition from the state VI to the state VII.

By using the processes of steps S58 and S62 in parallel to each other, the output destination determining/control portion 21 determines an input origin (that is, the operation origin) of the operation signal, discontinues (or maintains the discontinuation of) the output to an output destination that is different from the operation origin, and outputs (or maintains outputting) to an output destination that coincides with the operation origin.

When the pressing down of the Down key on the TV remote controller 5 is accepted in the state VII, the TV 4 only has to turn on its own power, and the TV 4 and the portable terminal apparatus 1 only have to execute the processes of steps S55 to S59. In this case, an UI image pointed by the cursor that is moved downward by one row from the UI image 22c is displayed on the displaying portion of the TV 4 instead of the UI image 23b.

The case where the operation of the portable key is executed at step S60 can be the time when viewing is transitioned to viewing of data that the user does not want to show to others (private data). In addition to the above (1) to (5), the private data can also be (6) image data itself used when the content of the image being output to the TV 4 is switched. The data of (6) can be image data itself of the time when the image being viewed on the web is switched to an image that the user does not want to show to the viewers in response to an operation of the user, and that of the time when the video image being received by One-Seg, etc., is switched to an image that the user does not want to show to the viewers in response to switching of the program or a change of the scene.

When the user has or is about to have no choice but to display such private data on the TV 4, the user is able to cause the display on the TV 4 not to be displayed by executing the operation on the operation input portion 17. It is assumed that, for example, in the case where the TV 4 and the portable terminal apparatus 1 are connected to each other and open data is being viewed on the TV 4, when electronic mail reception occurs, the user holds the portable terminal apparatus 1 in his/her hand and operates the portable terminal apparatus 1 main body to view the electronic mail received. This operation on the portable terminal apparatus 1 main body automatically discontinues the output to the TV 4 (and outputs to the displaying portion 14 of the portable terminal apparatus 1) and, thereby, the private data is prevented from being displayed on the TV 4 and viewed by the others.

Whether a piece of data corresponds to private data also differs depending on the viewers of the TV 4. However, the user is able to determine the above according to the case and set the data not to be displayed when necessary. Therefore, a setting to determine whether a piece of data is private data does not need to be stored inside the portable terminal apparatus 1.

On the other hand, when data that may be made open is viewed, the user only has to operate the portable terminal apparatus 1 using the TV remote controller 5 as described for step S54.

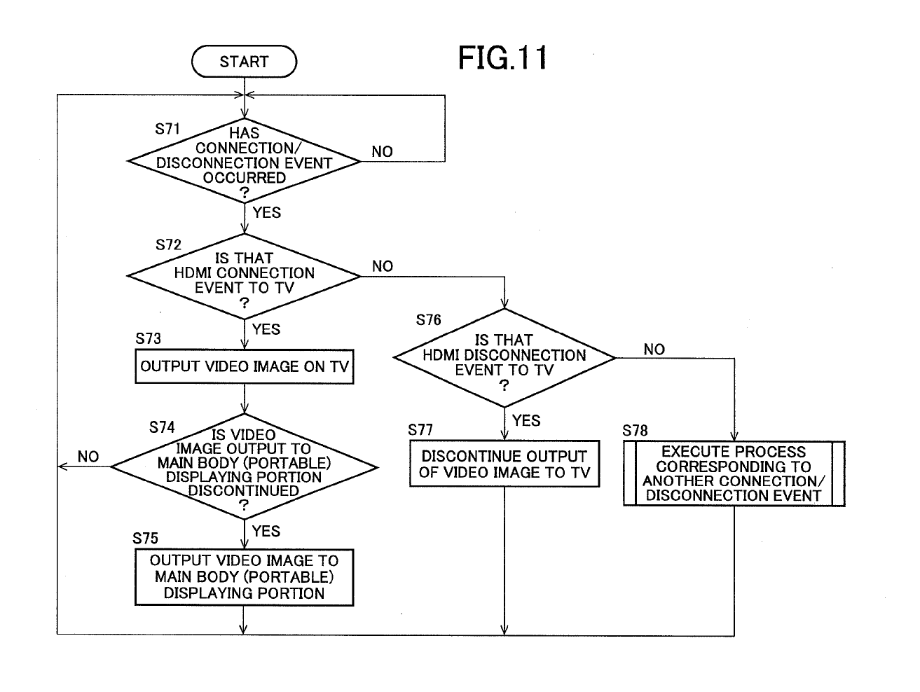

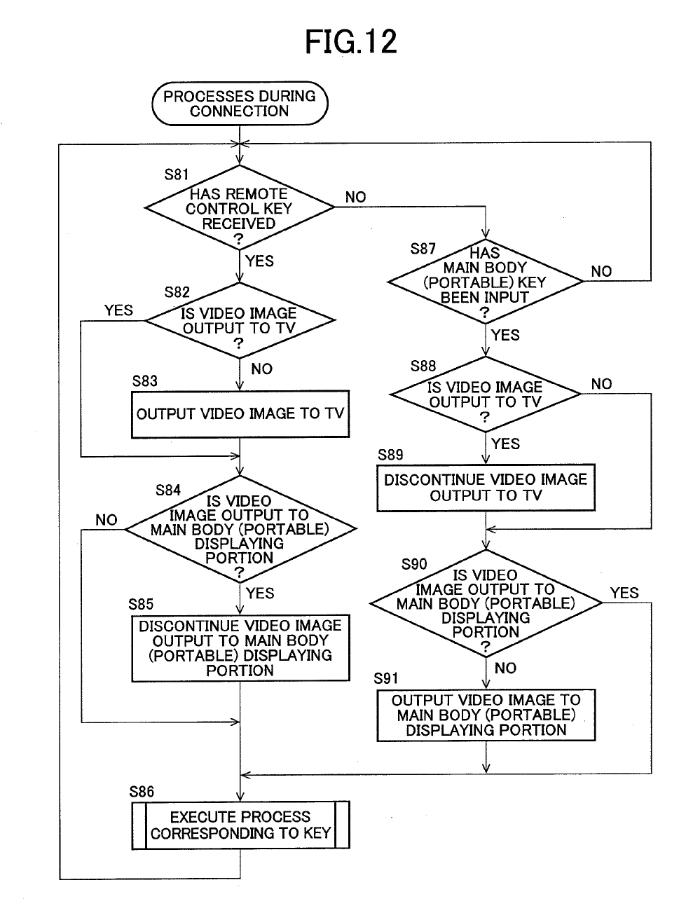

Next, a flow of processes in the portable terminal apparatus 1 will be described with reference to FIGS. 11 and 12. FIG. 11 is a flowchart for explaining another exemplary process executed for the occurrence of the event of the connection or the disconnection to/from the TV, and executed by the portable terminal apparatus in the display system of FIG. 1. FIG. 12 is a flowchart for explaining another exemplary process for the occurrence of the event of the user operation, and executed by the portable terminal apparatus in the display system of FIG. 1.

The event of the connection or the disconnection to/from the TV 4 will be described with reference to FIG. 11. The control portion 10 of the portable terminal apparatus 1 detects whether the event of the connection or the disconnection occurs concerning the connection to TV 4 similarly to step S21 of FIG. 7 (step S71). When the occurrence is detected, similarly to step S22, the control portion 10 determines whether the event is an event of an HDMI connection to the TV 4 (step S72).

When the determination result is YES at step S72, the output destination determining/control portion 21 selects the TV 4 as an output destination, and the external output data producing portion 23 and the external AV output portion 15 output the image (a video image) through the HDMI cable 3 (step S73). Following step S73 or prior to step S73, the output destination determining/control portion 21 also selects the displaying portion 14 as another output destination and determines whether the state currently is the video image outputting discontinued state for the outputting to the displaying portion 14 from the record in the ROM/RAM portion 16 (step S74). When it is determined that the state is the video image outputting discontinued state (when the determination result is YES), the output destination determining/control portion 21 controls the internal output data producing portion 22 to display an image (a video image) having the same content on the displaying portion 14 (step S75). After step S75, the procedure returns to step S71. When the determination result is NO at step S74, this image is already being displayed and, therefore, the procedure returns to step S71 without executing any process. These processes set the state to be, for example, the display state like the state V of FIGS. 9 and 10.

On the other hand, when the determination result is NO at step S72, similarly to step S25 of FIG. 7, the control portion 10 determines whether the event is an event of disconnecting the HDMI connection to the TV 4 or not (step S76). When the determination result is YES at step S76, the same process as that of step S26 (step S77) is executed and, when the determination result is NO at step S76, the same process as that of step S27 (step S78) is executed and the procedure returns to step S71.

Next, an event of a user operation will be described with reference to FIG. 12. The output destination determining/control portion 21 determines whether the output destination determining/control portion 21 receives the remote control key (the external operation signal) (step S81). When it is determined that the output destination determining/control portion 21 receives the remote control key (when the determination result is YES), the output destination determining/control portion 21 executes a process of selecting the TV 4 as an output destination. The output destination determining/control portion 21 determines whether a video image is being output to the TV 4 from the record in the ROM/RAM portion 16, etc., (step S82). When it is determined that no video image is being output (when the determination result is NO), the output destination determining/control portion 21 instructs the external output data producing portion 23 to output a video image, etc., and the external output data producing portion 23 and the external AV output portion 15 executes video image output through the HDMI cable 3 (step S83).

When the determination result is YES at step S82 and after the process of step S83, the output destination determining/control portion 21 receives the remote control key and, therefore, executes a process of excluding the displaying portion 14 as an output destination. And that is, the output destination determining/control portion 21 determines whether any video image is currently output to the displaying portion 14 or not from the record in the ROM/RAM portion 16, etc., (step S84). When currently outputting (when the determination result is YES), the output destination determining/control portion 21 instructs the internal output data producing portion 22 to discontinue the video image output, etc., and the video image output on the displaying portion 14 is discontinued (step S85).

When the determination result is NO at step S84 and after the process of step S85, a process is executed corresponding to the remote control key that is the origin for which it is determined at step S81 that the remote control key is received from this origin (a process of changing the video image) (step S86) and the procedure returns to step S81. Due to this process, the state becomes the display state like, for example, the state VI of FIGS. 9 and 10.

On the other hand, when the determination result is NO at step S81, the output destination determining/control portion 21 determines whether key (a portable key) inputting is executed on the operation input portion 17 or not (step S87). When the portable key inputting is not executed, the procedure returns to step S81. When the portable key inputting is executed (YES at step S87), the output destination determining/control portion 21 executes a process of excluding the TV 4 as an output destination. And that is, the output destination determining/control portion 21 determines whether any video image is currently output to the TV 4 from the record in the ROM/RAM portion 16 or not (step S88). When currently outputting (when the determination result is YES), the output destination determining/control portion 21 instructs the external output data producing portion 23 to discontinue the video image output, etc., and the external output data producing portion 23 and the external AV output portion 15 discontinue the video image output through the HDMI cable 3 (step S89). As above, simultaneously with this process of step S89, the output destination determining/control portion 21 may instruct the external operation input communicating portion 18 to issue a control signal to turn off the power of the TV 4 and the power of the TV 4 may be turned off.

When the determination result is NO at step S88 and after the process of step S89, the output destination determination/control portion 21 receives a portable key and, therefore, executes a process of adding the displaying portion 14 as an output destination. And that is, the output destination determining/control portion 21 determines whether any video image is currently output to the displaying portion 14 or not from the record in the ROM/RAM portion 16 (step S90). When not currently outputting (when the determination result is NO), the output destination determining/control portion 21 instructs the internal output data producing portion 22 to output a video image, etc., and the video image output on the displaying portion 14 is executed (step S91).

When the determination result is YES at step S90 and after the process of step S91, a process is executed corresponding to the portable key that is the origin for which it is determined at step S87 that the portable key is input (a process of changing the video image, etc.) (step S86) and the procedure returns to step S81. Due to this process, the state becomes the display state like, for example, the state VII of FIGS. 9 and 10.

As above, the portable terminal apparatus 1 that executes the non-display control has been described. However, the above discontinuation control portion may be adapted to execute the different-output control when the discontinuation control portion detects not only the input signal of the operation key but also either one of a signal indicating the detection of the moving of the portable terminal apparatus 1 and a signal indicating the detection of the variation of the physical shape of the portable terminal apparatus 1 as an internal operation signal. The discontinuation control portion only has to be adapted to execute the non-display control when the discontinuation control portion executes anyone of these three cases of detection. Naturally, the discontinuation control portion may execute the non-display control only when the discontinuation control portion detects the moving or may execute the non-display control only when the discontinuation control portion detects the variation of the physical shape. The detection of the moving and the detection of the variation of the physical shape are as above.

As above, the non-display control is executed in response to the moving or the variation of the physical shape of the portable terminal apparatus 1 and, thereby, it is more easily and instantly determined that the operation origin is the portable terminal apparatus 1. Therefore, the display on the TV 4 is able to be discontinued of the image from the portable terminal apparatus 1. Furthermore, such an action of the user such as holding the portable terminal apparatus 1 in his/her hand or varying its shape to be able to view the screen of the displaying portion 14 is a natural actin to be conducted for viewing the data on the portable terminal apparatus 1. Therefore, highly benefit is obtained because the image display on the TV 4 is able to be automatically discontinued with this natural action.

As above, an explanation has been done on the premise that the TV 4 is one that is connected to the portable terminal apparatus 1 capable of executing the non-display control. However, even when a plurality of external displaying apparatuses such as the TV 4 are connected to the portable terminal apparatus 1, the non-display control is applicable thereto.

And the explanation has been done on the premise that the data output from the portable terminal apparatus 1 capable of executing the non-display control to the external displaying apparatus such as the TV 4 is the image data (and the sound data). However, the idea of the non-display control is also applicable to the case where only the sound data is output from the portable terminal apparatus to an external sound output apparatus. In this case, control to mute the sound only has to be executed instead of the non-display control and, preferably, the portable terminal apparatus 1 is adapted to be able to change the sound to output in response, to an external operation signal from the external sound output apparatus similarly to the case of an image.

### EXPLANATION OF LETTERS OR NUMERALS

1 . . . portable terminal apparatus, 3 . . . HDMI cable, 4 . . . TV, 5 . . . TV remote controller, 10 . . . control portion, 11 . . . communicating portion, 12 . . . microphone, 13 . . . speaker, 14 . . . displaying portion, 15 . . . external AV output portion, 16 . . . ROM/RAM portion, 17 . . . operation input portion, 18 . . . external operation input communicating portion, 21 . . . output destination determining/control portion, 22 . . . internal output data producing portion, 22a, 22c, 23a, 23b . . . UI image, 22e, 40 . . . black screen, 23 . . . external output data producing portion, 30 . . . CEC command, 32 . . . header block, 32a . . . message transmission address, 32b . . . message reception address, 33 . . . control command

1.-4. (canceled)

5. A terminal apparatus capable of outputting an image to an external displaying apparatus, comprising:
a displaying portion;
a different-output control portion that, when the different-output control portion detects an operation signal of a main body of the terminal apparatus during display of the image on the external displaying apparatus, continues the display of the image on the external displaying apparatus and executes different-output control to display on the displaying portion another image that is different from the image;
an external operation signal receiving portion that receives an external operation signal from the external displaying apparatus; and
an operation origin determining portion that determines an operation origin from a result of determining which one of the external operation signal and the operation signal is detected, wherein
the different-output control portion executes the different-output control when an operation origin determined by the operation origin determining portion is the operation signal during the display of the image on the external displaying apparatus.

6. The terminal apparatus as defined in claim 5, wherein
the external operation signal is a remote control operation signal received through the external displaying apparatus from a remote controller to control the external displaying apparatus.

7. The terminal apparatus as defined in claim 5, wherein
the different-output control portion executes the different-output control when the different-output control portion detects as the operation signal any one of an input signal of an operation key, a signal indicating detection of moving of the terminal apparatus, and a signal indicating detection of variation of a physical shape of the terminal apparatus.

8. The terminal apparatus as defined in claim 6, wherein
the different-output control portion executes the different-output control when the different-output control portion detects as the operation signal any one of an input signal of an operation key, a signal indicating detection of moving of the terminal apparatus, and a signal indicating detection of variation of a physical shape of the terminal apparatus.
